(19) United States
(12) Patent Application Publication
(10) Pub. No.: US 2004/0124292 A1
(43) Pub. Date: Jul. 1, 2004

(54) Atomizer for a coating unit and method for its material supply

(76) Inventor: Stefano Giuliano, Gerlingen (DE)

Correspondence Address: Gregory D. DeGrazia, Howard and Howard Attorneys PC, 39400 North Woodward Avenue, Bloomfield Hills, MI, 48304-5151, US

(21) Appl. No.: 10/360,782

(22) Filed: Mar. 26, 2002

(30) Foreign Application Priority Data
Mar. 29, 2001 (DE) 101 15 463.1

(51) Int. Cl. B05B 5/00

(52) U.S. Cl. 239/690

(57) ABSTRACT

The atomizer (Z) of an electrostatic coating unit contains a dosing pump (DP) connected between the atomization device (4) and a scrapeable coiled pipe (10) which serves as a space-saving paint supply vessel and which is also situated in the atomizer. The scraper (12) is activated by compressed air on one side in order to force the paint material fed to its other side to the dosing pump (DP), which conveys it to the atomization device (4).

The invention concerns an atomizer and a method for material supply of an atomizer for a coating machine according to the preamble of the independent claims. The atomizer, in particular, is an electrostatic rotary or air atomizer mounted as a complete unit replaceably on a painting robot or other coating machine for the sequential coating of workpieces, such as vehicle bodies.

Such atomizers permit, among other things, advantageous paint change concepts and simple potential separation between electrostatic atomization devices operating with direct charging of the coating material and the paint supply system grounded for safety reasons, since the supply vessels are separated during coating from the grounded supply system and can be simply and automatically replaced for a paint change without or even with the actual atomizer. Known atomizers of this type contain dosing cylinders operated mechanically by a spindle drive (DE 196 10 588 A). Such dosing cylinders, however, have large space requirements stemming from their design. Their length, which is about twice as great as the piston stroke because of the piston rod, has an adverse effect mostly on painting robots or other handling machines on the accessibility of workpiece regions, such as vehicle interiors. Atomizers with hydraulically driven dosing cylinders are also already known (EP 0 967 01[illegible] A), whose compressed fluid, however, must be fed by a dosing pump located outside the atomizer.

Moreover, general problems develop in dosing cylinders, like high requirements on support and bearing to guarantee the desired dosing accuracy and dynamics, which not only increase the design expense, but also the weight of the atomizer to be supported by the wrist joint of a robot.

The objective of the invention is to provide a simply designed, reliable and not too heavy atomizer, whose feeding means suffices without hydraulic dosing and can be accommodated in a limited space, as well as a corresponding method for material supply of the atomizer.

This object is realized by the features of the patent claims.

The invention is suitable especially, but not exclusively, for electrostatic atomizers that are mounted as a whole replaceably on painting robots or other coating machines and permit in simple fashion both the required potential separation from the grounded supply system of the coating unit and rapid and problem-free paint changes without significant losses of paint and rinsing agents with an arbitrary number of selectable paints. For example, in the case of painting robots, it is also advantageous that costly hose lines can be dispensed with within the machine, since the internal feeding means of the atomizer can be filled with the atomizer disassembled.

The preferred design of a dosing pump designed as a geared pump in the atomizer has the advantage that a dosing cylinder of known type is unnecessary in this conventional, reliable component that has long proven itself.

The structure of the paint supply vessel as a wound tube has the advantage that, on the one hand, because of the significant reduction in diameter in comparison with ordinary cylindrical paint vessels, correspondingly lower paint change losses and losses of rinsing agent occur and, on the other hand, the design flexibility is improved especially with respect to space savings. The same applies to the likewise possible use of one or more rigid coiled pipes as paint supply vessel(s).

Since the wound tube or coiled pipe is preferably scraped in order to convey the coating material to the atomization device via the dosing pump and to force any residual paint back in the direction toward the grounded supply system of the coating installation, a very simple possibility is obtained at the same time for cleaning of the tube interior of the feeding means by the scraper in known fashion.

The invention is further explained in the practical example shown in the drawing. In the drawing:

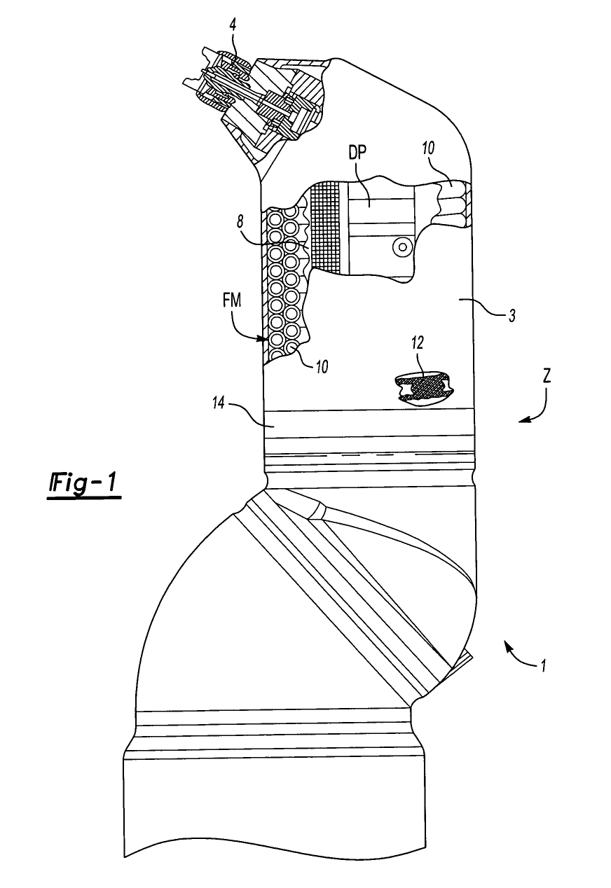

FIG. 1 shows an air atomizer mounted on the wrist joint of a painting robot;

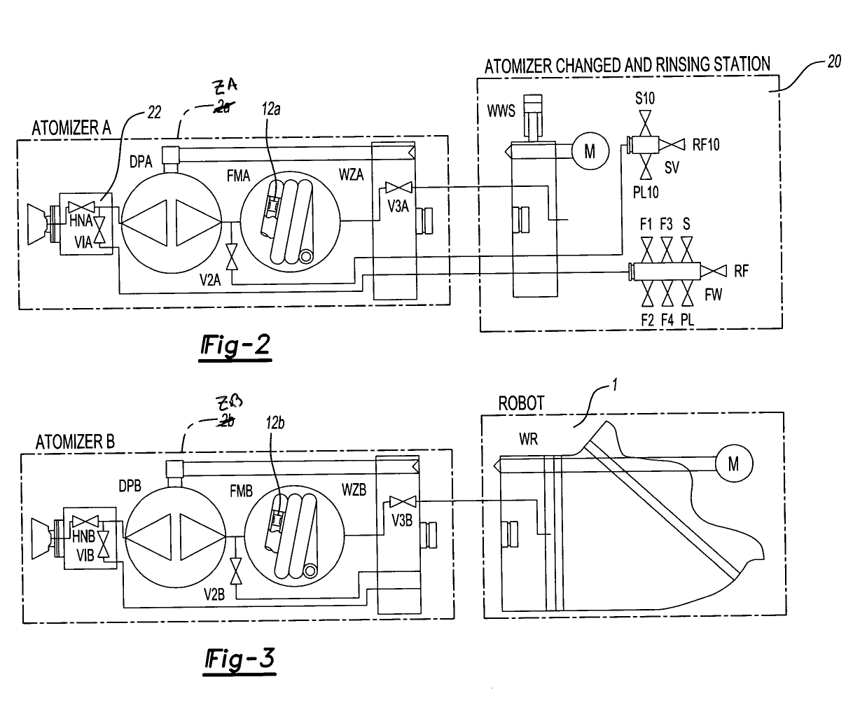

FIGS. 2 and 3 schematically show the paint supply concept for an atomizer of the type described here; and

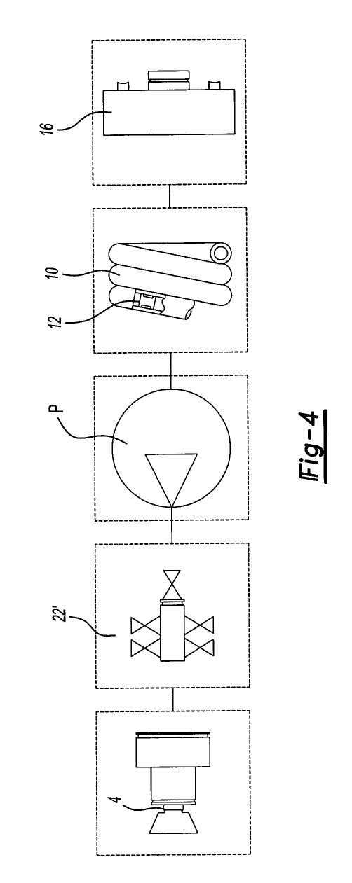

FIG. 4 shows a general view of the atomizer.

According to FIG. 1, an atomizer Z is mounted on wrist joint 1 of a robot, in whose housing 3 an air atomization device arranged in the front region, whose design and method of function are known and therefore require no explanation. The essentially cylindrical main part of housing 3 contains a dosing pump DP arranged coaxially in the middle of the housing, for example, a geared pump with an also known method of operation. The dosing pump DP is connected to atomization device 4 via valve unit 22 (FIG. 2) and can be controlled to convey in two opposite directions. The drive (not shown) of the dosing pump DP is expediently designed mechanically, for example, with a flexible shaft, which can be driven in turn via bevel gears and a pinion drive on the robot axis (by doubling of the robot axis usually referred to as axis 6). Another possibility is direct drive of the dosing pump DP by an electric motor situated in the atomizer.

A paint wound tube 10 of the shown two-layer coil form is arranged in the essentially annular space 8 in the cylindrical part of housing 3 surrounding the dosing pump DP, which serves as supply vessel for the coating material. One tube end is connected to the side of the dosing pump DP facing away from the atomization device 4, whereas the other tube end is connected to an external compressed air connection (V3A in FIG. 2).

A special feature of wound tube 10 serving as a supply vessel is scrapeability. Scraper 12 situated in paint tube FM of wound tube 10 can be pushed by compressed air from the mentioned compressed air connection through the entire wound tube in order to force the coating material situated in it to dosing pump DP. Appropriate scrapers for this purpose are known.

It is assumed in the following explanation of the method of operation that atomizer Z on flange 14 is mounted releaseably on robot wrist joint 1 and is removed for filling of wound tube 10 with coating material and connected to the filling station 20 shown in FIG. 2, serving also as an atomizer change and rinsing station.

The atomizer designated ZA in FIG. 2 contains valve unit 22 with the usual main needle valve HNA for the atomization device fed by pump DPA and a branching paint supply valve V1A, connected between the dosing pump DPA and the atomization device, shown here as a rotary bell. A rinsing and return line branches off via a valve V2A from the line connecting the dosing pump DPA to its opposite side with the paint tube FMA. Paint tube FMA is connected to a compressed air line with compressed air valve V3A on the end facing away from pump DPA.

The filling station 20 contains change system WWS that can be connected to change system WZA on the atomizer side, which includes a drive motor M that is mechanically connectable to dosing pump DPA. The station 20 also contains a rinsing valve arrangement SV connected to valve V2A when the atomizer is connected, with a rinsing valve S10, a pulse air valve PL10 and a return valve RF10, as well a paint changer FW connected to valve V1A with paint valves F1-F4, rinsing and pulse air valves S and PL and a return valve RF. The chosen coating material is forced from the paint changer FW through valve V1A and dosing pump DPA into the end of scrapeable paint tube FMA facing it, in order to fill it, in which scraper 12A is pushed in the direction toward the opposite tube end.

While the atomizer ZA is filled, coating can be carried out with another atomizer ZB connected to the robot hand axis 1 (FIG. 1), as shown in FIG. 3, where the elements corresponding to FIG. 2 are designated with B instead of A. The change system WZB on the atomizer side is coupled to the change system WR on the robot side. The scrapeable paint tube FMB is acted upon with compressed air via valve V3B so that the coating material fed into the tube is forced by scraper 12B to dosing pump DPB and from it conveyed to the atomization device.

The following cycle therefore occurs during an atomizer change with paint change.

Painting with atomizer ZB and first paint: the atomizer ZB is situated on the robot. The two halves of the change system WZB and WR are also coupled to the drive for the dosing pump DPB. The valves V1B and V2B are closed. Valve V3B releases compressed air so that scraper 12B is driven.

The scraper forces the first paint to dosing pump DPB during its movement in paint tube FMB between valves V3B and V2B and the pump doses the paint with the set painting speed, during which it is driven by motor M in the robot. The scraper separates the paint from the compressed air serving as scraper driving medium and simultaneously ensures the cleaning of the paint tube walls. When the main needle valve HNB is opened, the paint flows to the atomization device. The atomizer ZB operates under high voltage.

Start of a paint change program in the atomizer change, rinsing and filling station 20: with an impending paint change, an automatic rinsing and pressure program is started by the installation control. During spraying of the first paint through atomizer ZB, the other atomizer ZA, which is situated in the atomizer change and rinsing station 20, is prepared for the next painting task. The two halves of the change system WZA and WWS are connected here. All valves of station 20 are in their base position.

Rinsing of the atomizer ZA: in the subsequent rinsing process, the scraper 12A is situated in the paint tube FMA directly in front of valve V2A, since it is assumed that it has forced all the paint located in the paint tube during the last painting process (possibly with the exception of a safety volume). Valve V3A is opened so that the scraper is exposed to compressed air. Valve V2A now opens so that by altering opening of valves V10 and [illegible] on control valve SV, the rinsing agent-air mixture flows through the dosing pump DPA running at the rinsing speed and through the opened valve HNA. Thus, the atomizer ZA is rinsed from valve V2A via dosing pump DPA. (During rinsing, the pressure of the compressed air acting upon the scraper via valve V3A is greater than the pressure of the rinsing agent-air mixture.) The dosing pump DPA is driven by motor M in station 20 with valve HNA closed the paint changer FW is then briefly rinsed via valve V1A with valve RF open. Upon conclusion of the rinsing process, the entire system can be blown dry with a brief pulsed air interval.

Forcing of the second paint into atomizer ZA: The scraper 12A is situated near valve V2A when valve V3A is opened. After the rinsing process is complete, valves F2, V1A, V2A and RF10 are opened so that the second paint enters the paint channel. The dosing pump DPA runs backwards with the pressure speed. After a time stipulated by the control program according to the feed volume of the dosing pump, valve V2A is closed so that rinsing medium remaining in the paint tube is displaced and the system vented. After valve V2A is closed, the scraper is pushed by the paint column against the pressure of the compressed air to its other end position in the vicinity of valve V3A. After reaching the desired amount of paint by means of the dosing pump, the pressure process is ended. All mentioned valves go back to their base position. Atomizer ZA is now prepared for the next painting process and remains in station 20 until the next atomizer change.

Start of the atomizer change program and changing from atomizer ZB to atomizer ZA: after termination of the painting process with atomizer ZB, the dosing pump DPB is stopped, valve HNB is closed and the high voltage is then reduced. Atomizer ZB can now be replaced with atomizer ZA and a next workpiece painted with the second paint.

The described method of operation is only an example. The general atomizer system according to the invention shown in FIG. 4 with the connection flange 16, the scrapeable line coil 10, the pump P that conveys only in the direction to atomizer device 4 and the valve unit 22′ connected in-between can be operated in any other manner.

The invention is also not limited to the described examples. In particular, the wound tube or coiled pipe serving as supply vessel can also be advantageously connected without the downline dosing pump for space saving. On the other hand, a dosing pump connected in the atomizer between the paint supply vessel and the atomization device can also be expedient for any other type of container.

In the atomizer used here, the usual high voltage cascade required for electrostatic coating can also be present.

1. Atomizer for a coating machine that is mounted or can be mounted, especially replaceably, on a movable machine part (1) and contains in its housing (3) a feeding means (FM) connected to the atomization device (4) that serves as a supply vessel for the coating material, and to which the coating material can be fed by a dosing pump (DP), characterized by the fact that the dosing pump (DI) connected between the feeding means (FM) and the atomizer device (4) is situated in the atomizer housing (3).

2. Atomizer for a coating machine that is mounted or can be mounted, especially replaceably, on a movable machine part (1) and contains in its housing (3) a feeding means (FM) connected to the atomization device (4) and serving as a supply vessel for the coating material, and to which the coating material can be fed from the dosing pump (DP), especially according to claim 1, characterized by the fact that the supply device is formed by a coil-shaped wound tube (10) or coiled pipe.

3. Atomizer according to claims 1 and 2, characterized by the fact that the dosing pump (DP) is spatially arranged within the wound tube (10) or coiled pipe.

4. Atomizer according to one of the preceding claims, characterized by the fact that a geared pump is provided as dosing pump (DP).

5. Atomizer according to one of the preceding claims, characterized by the fact that the dosing pump is controllable so that it can convey in opposite directions.

6. Atomizer according to one of the claims 2 to 5, characterized by the fact that a scraper (12) movable through the wound tube (10) or coiled pipe is provided, which pushes out the coating material from the tube (FM) or pipe in the direction toward the atomization device (4) and is acted upon for this purpose by a pressure medium on the side facing away from the coating material.

7. Atomizer according to claim 6, characterized by the fact that the scraper (12) is driven with compressed air.

8. Atomizer according to claim 6 or 7, characterized by the fact that the wound tube (10) or coiled pipe is connected or can be connected on its material outlet end outside of the tube (FM) or pipe to the external material supply system (FW) of the atomizer.

9. Atomizer according to one of the preceding claims, characterized by the fact that the controllable dosing pump (DP) conveys the coating material from the feeding means (FM) to the atomizer device (4) in one direction, whereas it conveys the coating material into the feeding means (FM) in the opposite feed direction between it and the atomization device.

10. Atomizer according to one of the preceding claims, characterized by the fact that the dosing pump (DP) can be connected to a motor (M) arranged outside the atomizer via a flexible shaft.

11. Atomizer according to claim 10 on a painting robot, characterized by the fact that the flexible shaft is driven by a gear mechanism arranged in or on the wrist joint (1) of the robot on which the atomizer is mounted.

12. Atomizer according to one of the claims 1 to 9, characterized by the fact that the dosing pump (DP) is driven by an electric motor situated in the atomizer.

13. Method for material supply of an atomizer according to claim 1, characterized by the fact that for filling of the feeding means (FM) the coating material is guided into the connection between the feeding means (FM) and the dosing pump (DP) or into the connection between the dosing pump (DP) and the atomization device and that during coating the coating material is forced by compressed air from the feeding means (FM) into the dosing pump (DP) that conveys it to the atomization device (4).

14. Method according to claim 13, characterized by the fact that the coating material is forced from the dosing pump (DP) into the feeding means (FM) for filling.

15. Method according to claim 12 or 13, characterized by the fact that the coating material is forced by a scraper (12) through a line forming the feeding means (FM).
